(19) United States
(12) Patent Application Publication
(10) Pub. No.: US 2012/0053255 A1
(43) Pub. Date: Mar. 1, 2012

(54) Composite Polystyrene Particles and Methods of Making Same

(75) Inventors: Dennis W. Koerner, Memphis, TN (US); Michael Pate, Grandbury, TX (US); David Wilson, Eads, TN (US)

(73) Assignee: RAPAC, Oakland, TN (US)

(21) Appl. No.: 13/038,534

(22) Filed: Mar. 2, 2011

Related U.S. Application Data
(60) Provisional application No. 61/379,153, filed on Sep. 1, 2010.

(51) Int. Cl. C08L 25/06; C08J 9/18; C08K 5/098

(52) U.S. Cl. 521/59; 525/241; 524/399; 524/515

(57) ABSTRACT

Composite polystyrene particles have an average size less than 1200 μm and methods of making them are provided. The composite polystyrene particles can include recycled polystyrene obtained from a variety of sources. The composite polystyrene particles can be used in a variety of applications, including packaging materials and molded supports for the shipment of fragile objects.

### CROSS-REFERENCES TO RELATED APPLICATIONS

This application claims priority to U.S. Provisional Application Ser. No. 61/379,153, filed Sep. 1, 2010, which is hereby incorporated by reference in its entirety.

### BACKGROUND OF THE INVENTION

Polystyrene demonstrates several advantageous chemical and mechanical properties making it a desirable material for a variety of applications. Polystyrene is a rigid plastic demonstrating good mechanical strength with high dimensional stability attributed to interactions between its cumbersome aryl side chains. Moreover, polystyrene demonstrates acceptable optical clarity due to its amorphous nature and displays good resistance to aqueous acids and bases. Polystyrene is also easily processed as it has a low glass transition temperature (T_{g}). The foregoing properties result in polystyrene being used in over 6 billion pounds of plastics produced annually in the United States. Additionally, more than 700 million pounds of expandable polystyrene and styrene copolymers are produced annually in the United States.

The advantageous chemical and mechanical properties of polystyrene, however, have a negative environmental impact when articles constructed of polystyrene are discarded. As described above, polystyrene is chemically stable and in the absence of sun light is slow to environmentally degrade. Furthermore, environmental problems are compounded in the case of expandable polystyrene as the foamed nature of expandable polystyrene occupies a significant volume per unit mass, making disposal in space limited landfills challenging. Accordingly, there is a need to develop polystyrene materials and methods of making them that can incorporate recycled polystyrene.

### BRIEF SUMMARY OF THE INVENTION

Composite polystyrene particles are provided. In one aspect, the composite polystyrene particle includes a low molecular weight polystyrene component having an average molecular weight of less than 200,000 g/mol.

In one aspect, the low molecular weight polystyrene component is present in an amount of about 20% w/w to about 60% w/w, or about 30% w/w to about 50% w/w.

In one aspect, the composite polystyrene particle includes a high molecular weight polystyrene component having an average molecular weight of about 200,000 g/mol to about 300,000 g/mol.

In one aspect, the composite polystyrene particle has an average particle size of less than 1200 μm, or about 500 μm to about 1000 μm.

In one aspect, the composite polystyrene particle has a melt flow index of about 10 g/10 minutes to about 25 g/10 minutes, or about 12 g/10 minutes to about 17 g/10 minutes.

In one aspect, the high molecular weight polystyrene component comprises recycled polystyrene.

In one aspect, the high molecular weight polystyrene component has substantially no gas component.

In one aspect, the high molecular weight polystyrene component is present in an amount of about 40% w/w to about 90% w/w, or about 50% w/w to about 70% w/w.

In one aspect, the low molecular weight polystyrene component is present in an amount of about 20% w/w to about 60% w/w, or about 30% w/w to about 50% w/w.

In one aspect, the composite polystyrene particles have a spherical, aspherical, or elliptical shape.

In one aspect, the composite polystyrene particle contains a nucleating agent. In one aspect, the nucleating agent is a fatty acid salt. In one aspect, the nucleating agent is a metal salt of stearic acid, palmitic acid, oleic acid, or myristic acid. In one aspect, the metal salt is a zinc or calcium salt. Preferably, the nucleating agent includes zinc stearate.

In one aspect, the nucleating agent includes a polyethylene wax. In one aspect, the polyethylene wax has a molecular weight of about 400 g/mol to about 5000 g/mol. Preferably, the polyethylene wax has a molecular weight of about 3000 g/mol.

In one aspect, the nucleating agent is present in an amount of about 0.1% w/w to about 10% w/w, about 1% w/w to about 7% w/w, or about 2% w/w to about 6% w/w.

In one aspect, the composite polystyrene particle contains a blowing agent.

In one aspect, the blowing agent contains a hydrocarbon gas. In one aspect, the hydrocarbon gas can be n-pentane, isopentane, or a mixture thereof. Preferably, the hydrocarbon gas is about 85% w/w n-pentane and about 15% w/w isopentane relative to the amount of the hydrocarbon gas. In one aspect, the blowing agent is present in an amount of 1% w/w to about 10% w/w, or about 3% w/w to about 6% w/w.

In one aspect, the composite polystyrene particle contains a plasticizer.

In one aspect, the composite polystyrene particle has an average size of less than 1200 μm and comprises a fire retardant such as hexabromocyclodecane.

In one aspect, the composite polystyrene particle has an average size of less than 1200 μm and comprises a nucleating agent. In one aspect the nucleating agent is a metal salt such as zinc stearate, which can be present in an amount of about 1% w/w to about 3% w/w.

In one aspect, the composite polystyrene particle contains less than 3.5% w/w blowing agent. In one aspect, the composite polystyrene particle contains less than 3.5% w/w n-pentane.

In one aspect, the composite polymeric particle contains at least one low molecular weight polystyrene component and at least one high molecular weight polystyrene component, where the difference between the average molecular weight of the low molecular weight polystyrene component and the average molecular weight of the high molecular weight polystyrene component is at least 50,000 g/mol, or about 50,000 g/mol to about 60,000 g/mol.

In one aspect, a method of making a composite polymeric particle involves heating at least one low molecular weight polystyrene component and at least one high molecular weight polystyrene component to form a composite melt in a tandem extruder having a first extruder operably connected to a second extruder. At least one blowing agent is added to the composite melt. The composite melt is extruded from the first extruder to the second extruder, and cooled in the second extruder to form a polymer of polystyrene. The polymer is pelletized with an underwater pelletizer connected to the tandem extruder to form composite polystyrene particles. The composite polystyrene particles are then recovered.

In one aspect, composite polystyrene particles having an average particle size of less than 1200 μm are made by extruding a polystyrene composition through an extruder, e.g., a tandem extruder. In one aspect, such composite polystyrene particles are made by pelletizing the polystyrene composition with an underwater pelletizer.

### BRIEF DESCRIPTION OF THE DRAWINGS

FIG. 1 is a schematic representation of an exemplary apparatus for manufacturing the composite polystyrene particles.

### DETAILED DESCRIPTION OF THE INVENTION

I. Composite Polystyrene Particles

In one embodiment, composite polystyrene particles are provided. One way of characterizing the composite polystyrene particles and the polystyrene components described herein is by measuring the melt flow index. Melt flow indices can be obtained using standard measurement protocols known in the art, such as ASTM D1258 or ISO 1133. In one embodiment, the melt flow index is measured using the ASTM D1258 protocol.

Another way of characterizing polystyrene is by average molecular weight. Any of the standard molecular weight averages known to those of skill in the art can be used. For example, the average molecular weight can be measured as Mₙ (the number average molecular weight), M_{w} (the weighted average molecular weight), or M_{z} (the z-weighted average molecular weight). In one embodiment, average molecular weight is measured as the weighted average molecular weight (M_{w}).

In one embodiment, the particles include a low molecular weight polystyrene component having an average molecular weight of less than 200,000 g/mol, about 150,000 g/mol to about 180,000 g/mol, or about 150,000 g/mol to about 160,000 g/mol. Such low molecular weight polystyrene can be purchased from commercial suppliers and can comprise prime polystyrene. Prime polystyrene is polystyrene that has not been subjected to industrial processing after its synthesis.

The low molecular weight polystyrene component, in some embodiments, has a melt flow index of at least 12 g/10 minutes, at least 15 g/10 minutes or at least 20 g/10 minutes. In some embodiments, the low molecular weight polystyrene component has a melt flow index of about 12 g/10 minutes to about 30 g/10 minutes, about 15 g/10 minutes to about 25 g/10 minutes, about 20 g/10 minutes to about 25 g/10 minutes, or about 25 g/10 minutes to about 30 g/10 minutes. In one embodiment, the low molecular weight polystyrene has a melt flow index of about 23 g/10 minutes.

In some embodiments, composite polystyrene particles described herein have an average size of up to 100 μm, up to 200 μm, up to 500 μm, or up to 1000 μm. Composite polystyrene particles can also have an average size of about 200 μm to about 2000 μm, or about 500 μm to about 1000 μm. A polystyrene particle can have an average size of less than 1200 μm. In one embodiment, the composite polystyrene particles described preferably have a spherical, aspherical, or elliptical shape, although other shapes, such as rod shapes and rice shapes, are possible.

Unless otherwise specified, the percent amount of any component in a composite polystyrene particle is measured as the weight percent (w/w) relative to the weight of a given particle.

In some embodiments, the low molecular weight polystyrene component is present in the composite polystyrene particle in an amount of about 1 to about 80 percent, about 1 to about 40 percent, about 20 to about 60 percent, about 30 to about 50 percent, or about 10 to about 30 percent.

In one embodiment, the composite polystyrene particles include a high molecular weight polystyrene component having an average molecular weight of about 200,000 g/mol to about 300,000 g/mol. The average molecular weight of the high molecular weight polystyrene can be about 210,000 g/mol to about 220,000 g/mol, about 220,000 g/mol to about 230,000 g/mol, about 230,000 g/mol to about 250,000 g/mol, about 250,000 g/mol to about 270,000 g/mol, about 270,000 g/mol to about 290,000 g/mol, about 240,000 g/mol to about 280,000 g/mol, or about 290,000 g/mol to about 300,000 g/mol.

In one embodiment, the high molecular weight polystyrene component can comprise a mixture of two or more polystyrene components each of which can have an average molecular weight in any of the molecular weight ranges described above. In one embodiment, the average molecular weight of a mixture of two or more high molecular weight polystyrene components can be in any of the molecular weight ranges described above.

The high molecular weight polystyrene component can comprise a recycled polystyrene component. The recycled polystyrene component can comprise pre-consumer polystyrene. Pre-consumer polystyrene is polystyrene that was subjected to an industrial or manufacturing process, but has never reached a consumer as an end product. A variety of pre-consumer polystyrene sources can be used, e.g., off-grade polystyrene such as overs and unders. The recycled polystyrene component can also comprise post-consumer polystyrene. Post-consumer polystyrene is an article of manufacture that has been used by a consumer for its intended purpose and then discarded, e.g. polystyrene forks, spoons, cups, etc. A variety of post-consumer polystyrene sources can be used, including, but not limited to, plastic utensils, compact disk cases, and densified polystyrene. Both pre- and post-consumer polystyrene can be obtained from commercial suppliers well known to those of skill in the art.

A “recycled polystyrene component” is one that meets the requirements set forth in 16 C.F.R. §260, more specifically, at least the requirements in §260.7(e). In one embodiment, the recycled polystyrene is obtained from “[a] manufacturer [that] purchases material from a firm that collects discarded material from other manufacturers and resells it. All of the material was diverted from the solid waste stream and is not normally reused by industry within the original manufacturing process. The manufacturer includes the weight of this material in its calculations of the recycled content of its products. A claim of recycled content based on this calculation is not deceptive because, absent the purchase and reuse of this material, it would have entered the waste stream.” 16 C.F.R. §260.7(e), Example 2.

The high molecular weight polystyrene component can comprise polystyrene having no or substantially no gas component. In one embodiment, a high molecular weight polystyrene component with no gas component comprises high molecular weight polystyrene that is 99%, 99.5%, or 99.9% gas free. In one embodiment, a high molecular weight polystyrene component with substantially no gas component comprises high molecular weight polystyrene that is at least 95% gas free. In one embodiment, neither the low molecular weight polystyrene component nor the high molecular weight polystyrene component have a gas component, and the composite polystyrene particles made using these polystyrene components also do not comprise a gas component. In one embodiment, neither the low molecular weight polystyrene nor the high molecular weight polystyrene have a gas component and gas is optionally present in the composite polystyrene particle.

The high molecular weight polystyrene component, in some embodiments, has a melt flow index less than 12 g/10 minutes. The high molecular weight polystyrene component can have a melt flow index of about 1 g/10 minutes to about 12 g/10 minutes, about 5 g/10 minutes to about 12 g/10 minutes, about 3 g/10 minutes to about 10 g/10 minutes, or about 4 g/10 minutes to about 9 g/10 minutes.

The ratio of the melt flow index of the low molecular weight polystyrene component to the high molecular weight polystyrene component can be greater than 1, greater than 2, or greater than 5.

A composite polystyrene particle can comprise any desired amount of the high molecular weight polystyrene component. The high molecular weight polystyrene component of a composite polystyrene particle can present in an amount of about 1 to about 99 percent, about 1 to about 10 percent, about 10 to about 30 percent, about 30 to about 50 percent, about 50 to about 70 percent, or about 40 to about 90 percent.

In some embodiments, the composite polystyrene particle has a melt flow index of about 5 g/10 minutes to about 30 g/10 minutes, about 10 g/10 minutes to about 25 g/10 minutes, about 12 g/10 minutes to about 20 g/10 minutes, or about 12 g/10 minutes to about 17 g/10 minutes. In some embodiments, the composite polystyrene particle has a melt flow index of about 13 g/10 minutes. Without being bound by theory, a composite polystyrene particle with a melt flow index that is too low will be too brittle, while a particle with a melt flow index that is too high will not have the necessary rigidity to be useful in, for example, expandable polystyrene applications.

In some embodiments, composite polystyrene particles described herein, when expanded, have a finished product density of at least 1 lbs/ft³, at least 0.5 lbs/ft³, or at least 0.2 lbs/ft³. In some embodiments, composite polystyrene particles, when expanded, have a finished product density of about 0.1 lbs/ft³ to about 10 lbs/ft³.

In some embodiments, where the composite polystyrene particle comprises a low molecular weight polystyrene and a high molecular weight polystyrene, the difference between the average molecular weight of the low molecular weight polystyrene component and the average molecular weight of the high molecular weight polystyrene component is about 40,000 g/mol to about 150,000 g/mol, about 50,000 g/mol to about 140,000 g/mol, about 40,000 g/mol to about 50,000 g/mol, about 140,000 g/mol to about 150,000 g/mol, or about 50,000 g/mol to about 60,000 g/mol. In one embodiment, the difference between the average molecular weight of the low molecular weight polystyrene component and the average molecular weight of the high molecular weight polystyrene component is at least 50,000 g/mol. In another embodiment, the difference is about 56,000 g/mol. The difference in average molecular weights allows for a composite polystyrene particle to have a melt flow index that is consistent with the objectives of the present invention.

II. Nucleating Agents

A composite polystyrene particle can further comprise at least one nucleating agent. When a polystyrene particle comprises a nucleating agent, the nucleating agent is located in the interior of the particle. In one embodiment, a nucleating agent comprises a fatty acid salt. Exemplary fatty acid salts include, but are not limited to, metal salts of stearic acid, palmitic acid, oleic acid, or myristic acid. The metal component in the metal salt or salts can be any metal capable of forming a salt with an organic acid, such as zinc, magnesium, calcium, sodium, and the like. Thus, mono-valent metals (e.g., sodium) and di-valent metals (e.g., zinc, calcium) can be used as the metal component of a metal salt of a fatty acid. In some embodiments the fatty acid salt is a zinc or calcium metal salt. Preferably, the nucleating agent comprises zinc stearate.

Additionally, in some embodiments a nucleating agent can comprise a polyethylene wax. The polyethylene wax can have a molecular weight of about 400 g/mol to about 5000 g/mol. In additional embodiments, the polyethylene wax can have a molecular weight of about 700 g/mol to about 1300 g/mol, about 1500 g/mol to about 2500 g/mol, about 2500 g/mol to about 3500 g/mol, or any combination of the foregoing. Preferably, the polyethylene wax has a molecular weight of about 3000 g/mol. Exemplary polyethylene waxes that can be used include POLYWAX® polyethylenes. In one embodiment, the nucleating agent is a mixture of zinc stearate and POLYWAX® 3000. In one embodiment, the nucleating agent is a mixture of zinc stearate to polyethylenes in a ratio of about 1:2.

A nucleating agent can be present in a composite polystyrene particle in an amount up to 15 percent. In some embodiments, the nucleating agent can be present in a composite polystyrene particle in an amount of about 0.1 to about 10 percent, about 0.5 to about 8 percent, about 1 to about 7 percent, about 2 to about 6 percent, or about 1 to about 3 percent.

III. Blowing Agents

A composite polystyrene particle can further comprise at least one blowing agent. In some embodiments, a blowing agent comprises a hydrocarbon gas. In some embodiments, a hydrocarbon gas comprises n-pentane, isopentane, n-butane, isobutene, or mixtures thereof. A preferred blowing agent comprises a mixture of n-pentane and isopentane. A mixture of n-pentane and isopentane can comprise n-pentane in an amount of at least 70 weight percent, or at least 80 weight percent, or at least 85 weight percent, or at least 90 weight percent relative to the amount of blowing agent. Preferably, the blowing agent comprises a mixture of about 85 weight percent n-pentane and about 15 weight percent isopentane.

A blowing agent can be present in an amount of up to about 10 percent, up to 7 percent, up to 5 percent, or up to 3.5 percent. In another embodiment, the blowing agent is present in an amount of about 2 about 7 percent, or about 3 to about 6 percent.

IV. Other Additives

In some embodiments, a composite polystyrene particle further comprises at least one plasticizer. The plasticizer can be present in an amount of up to 0.5 percent or up to 0.1 percent. Any of the plasticizers known to those of skill in the art can be used. Phthalates, such as butyl benzyl phthalate, are one example of suitable plasticizers.

In some embodiments, a composite polystyrene particle described herein further comprises one or more surface additives. The surface additive is applied to the exterior of the composite polystyrene particle without penetrating its interior. A surface additive can comprise one or more fatty acid salts, monoglycerides, diglycerides, triglycerides, or mixtures thereof. A fatty acid salt surface additive can comprise any fatty acid salt described herein. Monoglyceride surface additives include, but are not limited to, glycerol monostearate, glycerol palmitate, and mixtures thereof. An exemplary diglyceride surface additive is glycerol distearate. An exemplary triglyceride surface additive is glycerol tristearate.

In one embodiment, the composite polystyrene particle described herein further comprises a fire retardant. Any of the fire retardants known to those of skill in the art can be used. An exemplary fire retardant is hexabromocyclodecane.

The composite polystyrene particles can be used in a variety of applications, including expandable polystyrene “peanuts,” and expandable polystyrene molded compositions such as those used to protect fragile objects during shipping.

V. Methods of Producing Composite Polystyrene Particles

Methods of producing composite polystyrene particles are provided. In one embodiment, the method comprises heating at least one low molecular weight polystyrene component and at least one high molecular weight polystyrene component to form a composite melt in a tandem extruder having a first extruder connected to a second extruder, adding at least one blowing agent to the composite melt, extruding the composite melt from the first extruder into the second extruder, cooling the composite melt in the second extruder to form a polymer, pelletizing the polymer with an underwater pelletizer connected to the tandem extruder to form composite polystyrene particles, and recovering the composite polystyrene particles.

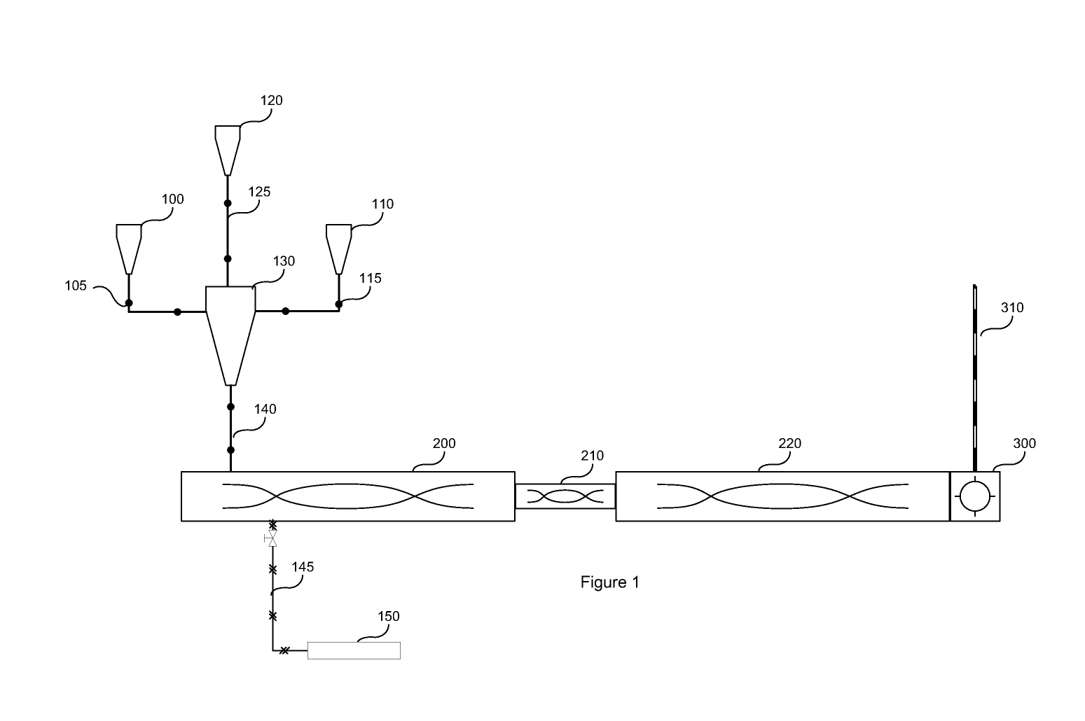

One method of producing a composite polystyrene particle begins by mixing low molecular weight polystyrene and high molecular weight polystyrene. As shown in FIG. 1, the low molecular weight polystyrene can be provided by feed source 100, and the high molecular weight polystyrene can be provided by feed source 110, which lead through conduits 105 and 115, respectively, to mixing chamber 130. The polystyrene components can be mixed in an extruder in addition to, or as an alternative to, a separate mixing chamber. The polystyrene components can be mixed in an extruder in addition to, or as an alternative to, a separate mixing chamber.

Any amount or combination of low molecular weight polystyrene and high molecular weight polystyrene described above can be used. For example, the mixture can comprise about 40 weight percent low molecular weight polystyrene (e.g., prime polystyrene) and about 60 weight percent high molecular weight polystyrene (e.g., recycled polystyrene). The recycled polystyrene component can already contain varying percentages of blowing agents, nucleation agents, plasticizers, fire retardants, and other additives, depending on the commercial source from which the recycled polystyrene component was obtained. For example, one commercial source of suitable recycled polystyrene comprises recycled polystyrene with about 4 weight percent blowing agents, about 2 weight percent nucleation agents, less than 1 weight percent plasticizers, and less than 2 weight percent fire retardants.

A mixture of low molecular weight polystyrene and high molecular weight polystyrene can be conveyed into a blending apparatus, which can comprise an extruder. An extruder can comprise a single screw extruder, a twin screw, or a multiple screw extruder. In some embodiments, the extruder is a tandem extruder. As shown in FIG. 1, the mixture can be conveyed through conduit 140 to a tandem extruder, which has a first extruder 200 operably coupled to a second extruder 220, e.g., by a gear pump 210 or other transfer apparatus. Exemplary extruders that can be used include PTI Trident Series 6000 and PTI Trident Series 8000 extruders.

The first and second extruders of a tandem extruder can have the same or different construction. In one embodiment, the first extruder is a twin-screw or multiple screw extruder, and the second extruder is a single-screw extruder. In another embodiment, the first extruder is a single-screw extruder, and the second extruder is a twin-screw or a multiple-screw extruder.

The mixture of low molecular weight polystyrene and high molecular weight polystyrene is heated in the first extruder 200 to a temperature sufficient to melt the entire mixture to form a composite melt. The composite melt can be homogeneous. The composite melt can reside in one or more extruders for any desired amount of time. The residence time of a composite melt in an extruder can depend on a variety of factors including, but not limited to, the melt flow index of the composite melt, the desired homogeneity of the composite melt, the incorporation of additives in the composite melt as well as other factors as would be apparent to one of ordinary skill in the art.

The method can further comprise adding at least one nucleating agent to the composite melt. The nucleating agent can be added to the mixing chamber 130 from nucleating agent fee source 120 through conduit 125. The nucleating agent can be of any type and added in any amount described in Section II above. A nucleating agent can be added to the composite melt in a carrier. For example, a nucleating agent can be compounded with carrier polystyrene before addition to the composite melt.

The method of making composite polystyrene particles can further comprise transferring or extruding the composite melt from the first extruder into a second extruder of a tandem extruder. For example, a melt pump or gear pump 210 can be used to transfer or extrude the composite melt.

A method of producing composite polystyrene particles can further comprise adding at least one blowing agent to the composite melt. The blowing agent can be of any type and added in any amount described in Section III above. A plasticizer according to Section IV above can also optionally be added. If a tandem extruder is used, the blowing agent and the plasticizer can be added while the composite melt resides in the first extruder or in the second extruder. For example, as shown in FIG. 1, the blowing agent can be added from blowing agent source 150 through conduit 145 to the first extruder 200.

A method of producing composite polystyrene particles can further comprise subjecting the composite melt to at least one temperature gradient. The composite melt can be subjected to a temperature gradient in the first extruder. For example, a composite melt is subjected to a zone in the blending apparatus held at a first temperature and a zone in the blending apparatus held at a second temperature, wherein the first temperature is greater than the second temperature. Alternatively, the first temperature can be less than the second temperature. The difference between the first and second temperatures can be about 5° F. to about 50° F., about 10° F. to about 40° F., or about 25° F. In one embodiment, the first temperature is about 350° F. to about 380° F., while the second temperature is about 340° F.

The composite melt typically begins to cool in the second extruder 220. Once the composite melt is sufficiently cooled in the second extruder, it forms a polymer that is extruded through a die and chopped to provide a plurality of composite polystyrene particles as described herein. In one embodiment, the die extrusion hole size is about 0.01 to about 0.1, about 0.01 to about 0.05, or about 0.02 inches in diameter. Preferably, an underwater pelletizer 300 coupled to the second extruder 220 is used to form the composite polystyrene particles from the polymer. A suitable underwater pelletizer can be obtained from Gala Industries of Eagle Rock, Va. The composite polystyrene particles formed during the underwater pelletization are spherical, aspherical, or elliptical in shape. Preferably, the composite polystyrene particles formed during the underwater pelletization have an average size of less than 1200 μm.

Alternatively, the composite melt is extruded into one or more strands that are subsequently cooled and cut to form the composite polystyrene particles. Composite polystyrene particles formed from chopping an extruded strand of the composite melt, in some embodiments, can have a rod shape or rice shape.

After pelletization, the composite polystyrene particles can be carried away in a water stream 310 used as part of the underwater pelletizer. The water stream 310 serves to convey and temper the composite polystyrene particles as they travel into a dewatering section of a dryer. The dryer can be any kind of apparatus capable of removing water, for example, a centrifugal dryer. As the composite polystyrene particles pass through the dryer the remaining water is removed. The composite polystyrene particles can be subsequently recovered. The composite polystyrene particles can be subject to further separation, depending on the specific need. For example, composite polystyrene particles can be further size screened and sorted according to methods well known in the art.

After recovery, the composite particles can be treated with one or more surface additives described in Section IV.

Several embodiments have been specifically illustrated and/or described herein. However, it will be appreciated that modifications and variations of these embodiments and the following non-limiting example are covered by the above teachings and within the purview of the appended claims without departing from the spirit and intended scope of the invention.

It must be noted that as used herein and in the appended claims, the singular forms “a,” “an,” and “the” include plural reference unless the context clearly indicates otherwise. Thus, for example a reference to “a particle” is a reference to one or more particles and equivalents thereof known to those of skill in the art.

### Example

500 lb of a single source of recycled material or a combination of sources of recycled polystyrene having a molecular weight between 240,000 g/mol and 280,000 g/mol, 208 lb of a prime polystyrene with a molecular weight of between 150,000 and 160,000 g/mol, and 64 lb of the nucleation agents (2:1 mixture of POLYWAX® 3000 and zinc stearate as a 2.5% mix in a polystyrene carrier) were fed to the feed throat of the primary extruder of a tandem extruder system. This mixture was melted at 350-380° F. and mixed in a series of high shear zones on the extruder screw to create a homogeneous polystyrene melt. The melt flowed through the mixing section on the extruder screw where 28 lb of pentane or a combination of pentane isomers were added under pressure. After the pentane is mixed, the polymer melt was metered to a gear pump using the metering section on the extruder screw, which moved the polymer from the first extruder to the second, or cooling, extruder. The second extruder was operated at 340° F. and acted to cool the molten polymer and meter a constant flow to the underwater pelletizer. Control of cooling of the molten polymer minimized swelling at the die. After pelletization, the material was dewatered, dried, and screened before applying external coating additives (800 ppm zinc stearate, 1000 ppm glycerol tristearate, and 100 ppm glycerol monostearate) with an additive feeder and continuous mixing system.

What is claimed is:

1. A composite polystyrene particle comprising a low molecular weight polystyrene component having an average molecular weight of less than 200,000 g/mol, wherein the composite polystyrene particle size is less than 1200 μm.

2. The composite polystyrene particle of claim 1, wherein the melt flow index of the composite polystyrene particle is about 10 g/10 minutes to about 25 g/10 minutes.

3. The composite polystyrene particle of claim 2, wherein the melt flow index of the composite polystyrene particle is about 12 g/10 minutes to about 17 g/10 minutes.

4. The composite polystyrene particle of claim 1, wherein the low molecular weight polystyrene component is present in an amount of about 20% w/w to about 60% w/w.

5. The composite polystyrene particle of claim 4, wherein the low molecular weight polystyrene component is present in an amount of about 30% w/w to about 50% w/w.

6. The composite polystyrene particle of claim 1, further comprising a high molecular weight polystyrene component having an average molecular weight of about 200,000 g/mol to about 300,000 g/mol.

7. The composite polystyrene particle of claim 6, wherein the high molecular weight polystyrene component comprises recycled polystyrene.

8. The composite polystyrene particle of claim 7, wherein the high molecular weight polystyrene component has substantially no gas component.

9. The composite polystyrene particle of claim 7, wherein the high molecular weight polystyrene component is present in an amount of about 40% w/w to about 90% w/w.

10. The composite polystyrene particle of claim 9, wherein the high molecular weight polystyrene component is present in an amount of about 50% w/w to about 70% w/w.

11. The composite polystyrene particle of claim 1, having a spherical, aspherical, or elliptical shape.

12. The composite polystyrene particle of claim 1, having a particle size of about 500 μm to about 1000 μm.

13. The composite polystyrene particle of claim 1, further comprising a nucleating agent.

14. The composite polystyrene particle of claim 13, wherein the nucleating agent comprises a fatty acid salt.

15. The composite polystyrene particle of claim 14, wherein the fatty acid salt is a metal salt of stearic acid, palmitic acid, oleic acid, or myristic acid.

16. The composite polystyrene particle of claim 15, wherein the metal salt is a zinc salt or calcium salt.

17. The composite polystyrene particle of claim 16, wherein the zinc salt is zinc stearate.

18. The composite polystyrene particle of claim 13, wherein the nucleating agent comprises polyethylene wax.

19. The composite polystyrene particle of claim 18, wherein the polyethylene wax has a molecular weight of about 400 g/mol to about 5000 g/mol.

20. The composite polystyrene particle of claim 19, wherein the polyethylene wax has a molecular weight of about 3000 g/mol.

21. The composite polystyrene particle of claim 13, wherein the nucleating agent is present in an amount of about 0.1% w/w to about 10% w/w.

22. The composite polystyrene particle of claim 21, wherein the nucleating agent is present in an amount of about 1% w/w to about 7% w/w.

23. The composite polystyrene particle of claim 22, wherein the nucleating agent is present in an amount of about 2% w/w to about 6% w/w.

24. The composite polystyrene particle of claim 1, comprising a blowing agent.

25. The composite polystyrene particle of claim 24, wherein the blowing agent comprises a hydrocarbon gas.

26. The composite polystyrene particle of claim 25, wherein the hydrocarbon gas comprises n-pentane, isopentane, or mixtures thereof.

27. The composite polystyrene particle of claim 26, wherein the hydrocarbon gas comprises about 85% w/w n-pentane and about 15% w/w isopentane relative to the amount of hydrocarbon gas.

28. The composite polystyrene particle of claim 24, wherein the blowing agent is present in an amount of about 1% w/w to about 10% w/w.

29. The composite polystyrene particle of claim 28, wherein the blowing agent is present in an amount of about 3% w/w to about 6% w/w.

30. The composite polystyrene particle of claim 1, further comprising a plasticizer.

31. The composite polystyrene particle of claim 1, further comprising a fire retardant.

32. The composite polystyrene particle of claim 31, wherein the fire retardant is hexabromocyclodecane.

33. A composite polystyrene particle having a size of less than 1200 μm and comprising a nucleating agent.

34. The composite polystyrene particle of claim 33, wherein the nucleating agent is a metal salt.

35. The composite polystyrene particle of claim 34, wherein the metal salt is zinc stearate.

36. The composite polystyrene particle of claim 35, wherein the zinc stearate is present in an amount of about 1% w/w to about 3% w/w.

37. A composite polystyrene particle comprising less than 3.5% blowing agent

38. The composite polystyrene particle of claim 37, wherein the blowing agent is n-pentane.

39. A composite polystyrene particle comprising:
at least one low molecular weight polystyrene component, and
at least one high molecular weight polystyrene component,
wherein the difference between the average molecular weight of the low molecular weight polystyrene component and the average molecular weight of the high molecular weight polystyrene component is at least 50,000 g/mol.

40. A method of making composite polystyrene particles comprising:
a) heating at least one low molecular weight polystyrene component and at least one high molecular weight polystyrene component to form a composite melt in a tandem extruder having a first extruder operably connected to a second extruder;
b) adding at least one blowing agent to the composite melt;
c) extruding the composite melt from the first extruder to the second extruder;
d) cooling the composite melt in the second extruder to form a polymer;
e) pelletizing the polymer with an underwater pelletizer operably connected to the tandem extruder to form composite polystyrene particles; and
f) recovering the composite polystyrene particles.

41. A method of making composite polystyrene particles having a particle size less than 1200 μm by extruding a polystyrene composition through an extruder.

42. The method of claim 41, wherein the extruder is a tandem extruder.

43. The method of claim 42, further comprising pelletizing the polystyrene composition with an underwater pelletizer.
